(19) United States
(12) Patent Application Publication
(10) Pub. No.: US 2017/0001447 A1
(43) Pub. Date: Jan. 5, 2017

(54) PRINTING OF DIGITAL IMAGES ONTO FIBERGLASS

(71) Applicant: John Reinhard, Costa Mesa, CA (US)

(72) Inventor: John Reinhard, Costa Mesa, CA (US)

(21) Appl. No.: 15/194,466

(22) Filed: Jun. 27, 2016

Related U.S. Application Data
(60) Provisional application No. 62/188,228, filed on Jul. 2, 2015.

(51) Int. Cl. B41J 3/407; B63B 35/79

(52) U.S. Cl. CPC B41J 3/4073; B63B 35/7909

(57) ABSTRACT

Processes, systems and methods for applying graphics digitally to fiberglass, along with products thereby including surfboards, allowing a true image to be conformably disposed upon geometrically complex surface without spherical or chromatic aberration detectable by the human eye. Unexpectedly, by applying digital elements as structural features, the graphics make the board stronger and less subject to breakage and delamination issues.

### CROSS-REFERENCE TO RELATED APPLICATIONS

This application claims the benefit of and priority to U.S. Provisional Patent Application No. 62/188,228, filed Jul. 2, 2015, the entire contents of which are incorporated hereby by reference.

### BACKGROUND OF THE PRESENT DISCLOSURE

The present disclosure relates to graphical images and applying them to fiberglass, woven and laminated products.

In particular, the instant disclosure relates to using improved methods to match and enhance print quality and the images that can be used for printing onto fiberglass, and related surfaces.

Within many leisure-based industries, the digital revolution has enabled users to develop graphics using tools and resources which development of highly creative, or exploitation (subject to Copyright law and related legal conventions) of digitally stored or rendered images, including of well renowned works of science and art.

The ability to use such images, in addressing the outer surfaces finishes visually presented with the context of various articles of manufacture, has become both challenging and highly rewarding to those in various industries.

Prior to the advent of the instant system, it was heretofore unknown how to solve the problem of reproducing true images upon geometrically complex surface areas without human error being introduced into the process. It is respectfully submitted that enumerating the scope and bounds of, and solving this problem for woven materials constitutes progress in science and the useful arts worthy of Letters Patent.

### OBJECTS AND SUMMARY OF THE DISCLOSURE

Briefly stated, processes, systems and methods for applying graphics digitally to fiberglass, along with products thereby, including surfboards, for example.

According to embodiment, a process for applying graphics directly onto surfaces, which comprises, in combination, providing at least a desired image digitally rendered, sizing and uploading said at least a desired image, applying said at least a desired image to the surface, and finishing over layers upon the surface.

According to embodiments, the process of claim 1 is described in detail for an exemplary embodiment, namely wherein the surface is disposed upon on a surfboard, or related articles for leisure and other uses.

According to embodiments, there is disclosed A method of making a fiberglass article having a true image conformably applied to a least a portion of its surface, comprising, in combination, providing at least a fiberglass core and a desired image digitally rendered, sizing and uploading said desired image into a printer, including profile calibration and color settings, applying said at least a desired image to the surface whereby the integrity of the desired image digitally is rendered conformably, that is without spherical or chromatic aberration upon the surface, and finishing over layers upon the surface to preserve by lamination the outer integrity of the surface of the now digitally conformably rendered image disposed upon said fiberglass core.

Those skilled in the art readily understand that it has been a holy grail in, for example, the surf industry to combine user-driven graphics and the best boards available in the marketplace. Until now, customized surfboards were laboriously made aesthetically charming by an expensive, imperfect and non-scalable process only. Prior to the advent of the instant teachings this craft made true image reproduction too challenging—it is respectfully submitted. Now, if licensed, one could use works of the Great Masters to adorn the surface of any desired leisure or other article, as a true image.

### BRIEF DESCRIPTION OF THE DRAWING

FIG. 1 is a schematic of a process according to the teachings of the instant disclosure, showing steps involved in the instant teachings.

FIG. 2 shows additional background for the exemplary embodiments depicted in FIG. 1.

### DETAILED DESCRIPTION OF THE DISCLOSURE

The present inventor, in seeking to provide users of, for example, fiberglass-based articles, with graphical images that are true representations of the images desired, has done so in a way which has improved the structural integrity of the articles also being a result of the approach which works best to reproduce the images.

The present inventor has discovered that after experimenting and perfecting the technique his team can now print complex graphics, digitally directly onto irregular woven substrates, including for example fiberglass surfaces. In doing this, the ability to adorn objects has been substantially improved, along with concomitant increases in structural integrity.

Throughout the instant specification the term “substrate” is used in its plain language meaning namely as a “base . . . or substance acted upon” for the purpose of this application that includes any articles of manufacture having a woven or stranded surface.

For illustrative purposes only, the instant specification focus upon an article commonly used for the globally popular sport of surfing, in that it provides a species of the genus which applicant is believed to have invented.

By way of example, in the surfboard arts it has been challenging to have fully compliant graphics applied to and/or laminated into the articles such as consumer-desired goods.

The following U.S. Letters Patents and Patent Application Publications are expressly incorporated by reference as if fully set forth herein, each having had been examined and found to be distinguishable from the instant teachings:

U.S. Pat. No. 8,975,769; U.S. Pat. No. 7,897,233; U.S. Pat. No. 7,582,236; U.S. Pat. No. 7,534,153; U.S. Pat. No. 7,404,749; US 2005/0206130; and U.S. Pat. No. 5,816,876.

The prior art shows what is believed to be the state of the art in application of graphics to, for example, surfboards. Namely, either images done by hand or silk-screening techniques separately are then applied to the complex geometry of the surfboard. Owing to the physics driving the low-friction interface desired with the water, the shape of a surfboard is not a simple geometric form.

Prior art attempts to use graphics appear to hinder, as opposed to being consistent with, the streamlined complex geometry required. This is because it has not heretofore been explained how to map a digital image upon the curved substrate shaped to be a surfboard, inter alia.

The present invention is available currently in Orange County, Calif. (BoardLams, 774 W 17^{th} Street, Costa Mesa, Calif. 92627), and enables any digitally stored image to be transferred to a surfboard core/substrate and to be processed, into the shape of the board without changing it.

For example, a Hewlett Packard Latex 360 i1 color printer can be programmed with appropriate color and print settings data to generate the optimum color profile for fabric which received the digital image without optically aberrating the same.

As explained in detail with reference to the below figure, fabric can be obtained from known sources (for example BGF Industries, A Porcher Industries Company, Greensboro, Nev. 27410) with data sheets reflecting the style (e.g. 220); Finish (Untreated); Fiber Type (Glass); Weave Pattern (4 HS) along with Density, Warp Yarn and Fill yarn settings; Breaking strength, Warp, Fill and Count along with desired weight and thickness.

Applicant has discovered that the ostensive resolution issues with other systems can be overcome by optimizing the quality by number of passes and ink saturation. Surprisingly, surfboards to date have not incorporate structural elements which are also graphics.

The buoyancy of any load carrying vessel that floats in water, such as a boat, a raft, or a surfboard is explained by Archimedes' principle, which was enunciated more than 200 years before the birth of Christ. Archimedes' principle states that a body immersed in a fluid is buoyed up by a force equal to the weight of the fluid it displaces. The following discussion is focused entirely on the application of the principle to water-borne surfboards carrying a surfer, although the principle can be applied to other objects, fluids and gases as well. In determining whether a surfboard carrying a surfer will float in water, we must first have knowledge of the combined weight of the surfer and the board, the volume of the surfboard alone, and the weight of a volume of water equal to the volume of the surfboard. If the combined weight of the surfer and the surfboard is less than the weight of a volume of water equal to that of the surfboard, the surfboard will float and carry the surfer. For example, if a surfer weighs 70 Kg. (154 lbs.) and the surfboard weighs 10 Kg. (22 lbs.) the board and its surfer will float if the weight of water displaced by the surfboard is more than 80 Kg. (176 lbs.), i.e. a volume of about 80 L. (21 gal.). If the surfboard has a total volume of say, 120 L. (32 gal.) then two thirds of its volume will be submerged, displacing in the process a volume of fluid whose weight is equal to the combined weight of the surfer and the surfboard. In striving to produce a surfboard capable of carrying a surer, it is clear that only the characteristics of the surfboard can be varied, inasmuch as the weight of the surfer is fixed by the user. Therefore, even without considering the exact details of the weights involved, it will be clear from this discussion that a relatively heavy (high-density) material, such as wood, will necessarily result in a large, heavy surfboard to provide flotation for an average surfer—this is the reason that the early wooden boards were “long (and) cumbersome” as stated in the third paragraph of this discussion. By contrast, a relatively light (low-density) material, such as cork, is capable of providing a smaller, lighter surfboard capable of providing flotation for the same individual.

However, another crucial factor that has to be considered in surfboard design is the mechanical strength and structural integrity of the board under mechanical stress. Anyone who has viewed a crashing surf will have been awed by its power. Surfboards, like boats, must have the mechanical strength and structural integrity to withstand not only the power of the sea, but also of the stresses produced by the weight and actions of the surfer as he or she rides and controls the board. Such stresses may be divided into horizontal stresses, which are stresses perpendicular to the horizontal lane of the surfboard as it floats, and lateral stresses, which are stresses perpendicular to the horizontal stresses. Such lateral and horizontal stresses may be simulated under test conditions comprising brick testing and other methods known to those in the surf arts.

Surfers and those familiar with the surfing arts can identify the various parts of a surfboard by a number of conventional terms. The leading edge of the board, which would be called the bow of a boat, is called the “nose”. The trailing edge of the board, which would be called the stem of a boat, is called the “tail”. As with a boat, the edges connecting the nose and the tail are called “rails”. The upper surface of the board, when floating in the water, is called the “dorsal” surface, whereas the surface in contact with the water is called the “ventral” surface.

In brick testing, a surfboard is laid on two supports, or stands, in a manner such that one support is under the nose of the board, whereas the other support is under the tail of the board. One or more bricks is then placed in the middle of the dorsal surface of the board. Bricks are added one-by-one until the breaking strength of the board is reached, and the board breaks. If several boards of differing construction are subjected to this test, the number of bricks that each board will support provide a measure of the strength of the board, and of its ability to support a surfer engaged in surfing under extreme conditions.

It is obvious that a cork surfboard would not be capable of supporting many bricks under these conditions, because it is well known that cork is easily broken. For these reasons, a cork surfboard as described above, would be unsuitable for any serious use because of its limited structural integrity.

Still another crucial factor that has to be considered in surfboard construction is the resistance of the construction material to structural degradation by the action of water. Although wood and cork enjoy a robust resistance to the effects of immersion in water, the same cannot be said for other light materials capable of being formed into strong structures; for example structural cardboard. Thus, although surfboards may be made of a variety of materials, the threefold constraints of lightness, strength and resistance to water have resulting in the increasing importance of surfboards made from plastic-based materials in recent years.

A plastic is defined as any organic material with the ability to flow into a desired shape when heat and pressure are applied, and to retain the shape when they are withdrawn. A plastic is made up principally of a binder, together with plasticizers, fillers, pigments, and other additives. The binder gives a plastic its main characteristics and usually its name. Thus, polyvinyl chloride is both the name of a binder and the name of a plastic into which it is made. Binders may be natural materials, e.g. cellulose derivatives, casein or milk protein. But more commonly binders are synthetic resins. In either case, the binder materials consist of very long chainlike molecules called polymers. Cellulose derivatives are made from cellulose, a naturally occurring polymer; casein is also a naturally occurring polymer.

Plasticizers are added to a binder to increase flexibility and toughness. Fillers are added to improve particular properties, e.g. hardness or resistance to shock. Pigments are used to impart various colors. Virtually any desired color or shape and many combinations of the properties of hardness, durability, elasticity, and resistance to heat, cold and acid, can be obtained in a plastic.

There are two types of plastic: thermosets, which cannot be resoftened after being subjected to heat and pressure; and thermoplastics, which can be repeatedly softened and remolded by heat and pressure. Plastics, also called synthetic resins are polymerized, or built up, from small simple molecules called monomers. When heat and pressure are applied to a thermoplastic binder, these chainlike molecules slide past each other giving the material “plasticity”. By contrast, when heat and pressure are initially applied to a thermosetting binder, the molecular chains become joined or “crosslinked”, thus preventing any slippage if heat and pressure are reapplied. Thermosets are usually supplied as partially polymerized or as monomer-polymer mixtures. Cross linking is achieved during fabrication using chemicals, heat or radiation; this process is called curing or vulcanization. Important thermosets include phenol-formaldehyde, epoxy, diallyl phthalate, polyester, urea-formaldehyde, and melamine-formaldehyde, within the context of the instant teachings.

Plastic articles are commonly manufactured from thermoset plastics in which desired shapes are fashioned by molding. The monomer or partially polymerized mixture is treated with a curing agent and placed in a mold to harden. Reinforcement means can be introduced during this process, which is used for designs with intricate shapes and great variations in wall thickness. Among the plastics used for making plastic articles, including plastic surfboards, are epoxy resins, polypropylene, polyolefins, polyethylene, vinyl plastics, polycarbonates, polyacrylics, polyvinyl chloride polystyrene phenolics, ureas, melamines, polyesters, silicones, rubbers and polyurethanes.

Plastics may be used as such, or may be reinforced by fiberglass and other reinforcing materials in making surfboards and certain other plastic articles. Fiberglass is a thread made from glass. It is made by forcing molten glass through a kind of sieve, thereby spinning it into threads. Fiberglass is strong, durable and impervious to many caustics and to extreme temperatures. For those qualities, fabrics woven from the glass threads are widely used for industrial purposes. A wide variety of materials are made by combining fiberglass with plastic. These materials, which are rust proof, are molded into the shape required or pressed into flat sheets. Surfboards reinforced with fiberglass are made by the molding process.

Other fibers can be used as a reinforcement for plastic articles including surfboards. Of special value in this connection is polyester fiber. Polyester is a man-made fiber produced by the polymerization of the product formed when an alcohol and organic acid react. The outstanding characteristics of polyesters are their strength and dimensional stability. Rope made of polyester is used widely for marine applications, where these qualities are highly desirable. For the same reason, polyester fabric is well suited as a reinforcement for plastic articles. Still another type of plastic construction that can be used in the construction of surfboards is a plastic foam core. Such a foamed plastic can be made from polystyrene or polyurethane. Polystyrene is a widely used plastic that is a polymer of styrene. Polystyrene is a colorless, transparent thermoplastic that becomes a viscous liquid at about 185° C., (365 F.) and is resistant to acids, alkalis, oils and alcohols. It may be produced as a light foamed plastic marketed under the trade name STYROFOAM that can be produced in any of a variety of shapes.

Polystyrene foam has two important properties that make it of great potential value in surfboard construction. First, it is a thermoplastic plastic that can readily be produced in a surfboard shape. Second, it is a very low-density, light plastic because of its high air content. Buy a particular problem associated with the use of polystyrene is its relatively weak structural integrity. By contrast to wood or metal, an unmodified polystyrene surfboard would break easily in the brick test. As a result, an unmodified polystyrene surfboard would not be suitable for surfing because of the likelihood of surfboard failure.

A group of related and prominent concerns addressed by the instant teaching are the case of damage to the rails of the board by rocks, shells, sand, and other hazards encountered under surfing conditions.

Still another deficiency ameliorated by the present invention is tendency of surfaces moving through water to vibrate. This impacts upon surfing as it increases the friction, or “drag” encountered by the surface with consequent slowing of the motion. This phenomenon is well known in both hydrodynamics and aerodynamics.

Yet another problem connected with the use of white plastic surfboards is the “low-budget”, inelegant appearance of these articles. The absence of any texture or color in the surface leads to this undesirable appearance. As pioneers and innovators attempt to make surfboards stronger, stiffer and longer lasting, none has approached these problems in combination with dynamic cosmetic appeal.

Each of these distinct, but significant concerns is ameliorated by the present invention as developed below and desired by the claims offered for consideration herein.

By way of background, attention is called to the following. A solution to the problem of weakness of polystyrene foam core members has been to fabricate polystyrene foam surfboard core members reinforced in the following manner. The core member is cut into two halves, by means of a cut at right angles to the dorsal surface extending from the nose to the tail. A wooden beam member is then interposed between the two halves and affixed to each of them. The wooden beam member is further secured to the dorsal and ventral surfaces by means of fiberglass fabric strips along its length affixed by a plastic coating. In effect, the wooden beam member, together with the affixed fiberglass strips, forms an engineering “I-beam” which stiffens the entire board. Further reinforcement is provided by a layer of fiberglass fabric reinforcement embedded in a plastic coat covering the entire core member, even though such surfboards have become popular consumer goods, such prior art reinforcement systems have not adequately addressed the required need for structurally enhanced surfboards as set forth below.

Variations on the known surfboard reinforcement systems have not been forthcoming, despite recent developments in the technology related to the manufacture of articles made of plastic. Thus, while it has been known to use material fabric cosmetically on surfboards, such disclosures have not adequately addressed uses of same in a structural sense. Neither have any known surfboards used fabric on anything but the deck, or bottom of the surfboards, in the matter taught by the present teachings. Likewise, in the last two decades, the present inventor, as the man of skill in the theory of the surf arts has unearthed no disclosure to date employing fabric layers in a way which provides the degree of mechanical strength, stability and structural integrity of the subject surfboard, let alone solved said issue and enhanced the visual appeal.

By way of further background, attention is called to the following U.S. Letters Patent, which are illustrative of the state of the surfing, arts: U.S. Pat. Nos. 4,521,011; 4,789,368; Des. 307,310; and 4,932,911.

In contradistinction to all of these surfboard modifications, the present invention embraces and finally addresses the clear need for a surfboard having fabric reinforcements which facilitate operational functionality while offering ornamental amelioration. Thus, as pioneers and innovators attempt to make surfboards better, stiffer and longer lasting, none has approached same in combination with dynamic cosmetic appeal-until the teachings of present invention. It is respectfully submitted that other references merely define the state of the art or show the type of systems which have been used to alternately address those issues ameliorated by the teachings of the present invention. Accordingly, further discussions of these references has been omitted at this time due to the fact that they are readily distinguishable from the instant teachings to one of skill in the art.

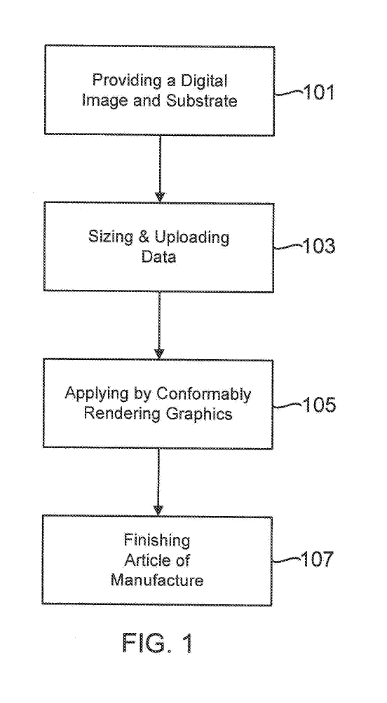

Referring to FIG. 1, steps according to the instant teaching are shown, although those of skill in the art understand that the order is not critical and that this is one way only to perform the process, simplified for explanation:
In short, the method of making a fiberglass article of manufacture having a true image conformably applied to a least a portion of its surface, comprises; 101
providing at least a substrate which is a fiberglass core and a desired image digitally rendered; 105, sizing and uploading said desired image into a printer, including profile calibration and color settings; 107, applying said at least a desired image to the surface whereby the integrity of the desired image digitally is rendered conformably, that is without spherical or chromatic aberration upon the surface; and 109, finishing over layers upon the surface to preserve by lamination the outer integrity of the surface of the now digitally conformably rendered image disposed upon said fiberglass core, whereby structural integrity is enhanced by physical and chemical integration of the digitally conformed image to the surface contours of the article of manufacture.

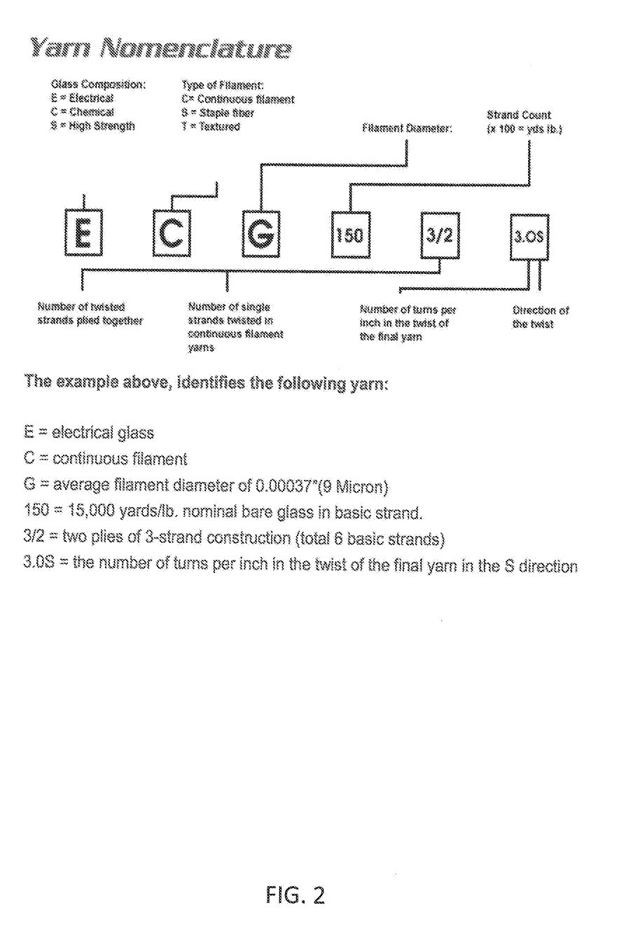

FIG. 2 shows additional background for the exemplary embodiments depicted in FIG. 1, namely the glass composition; filament type and diameter; strand count, number of twisted strand parts plied together, number of single strands, number of turns and direction of twist. Each of these definitions in incorporated in the claim below to define the said exemplary embodiment shown.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Reference throughout this specification to “one embodiment,” “an embodiment,” or similar language mans that a particular feature, structure, or characteristic described in connection with the embodiment is included in at least one embodiment of the present invention. Thus, appearances of the phrases “in one embodiment,” “in an embodiment,” and similar throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

A processor may be provided by one or more processors including, for example, one or more of a single core or multi-core processor (e.g., AMD Phenom II X2, Intel Core Duo, AMD Phenom II X4, Intel Core 15, Intel Core i& Extreme Edition 980X, or Intel Xeon E7-2820).

An I/O mechanism may include a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-Fi card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

Memory according to the invention refers to a non-transitory memory which is provided by one or more tangible devices which preferably include one or more machine-readable medium on which is stored one or more sets of instructions (e.g., software) embodying any one or more of the methodologies or functions described herein. The software may also reside, completely or at least partially, within the main memory, processor, or both during execution thereof by a computer within system, the main memory and the processor also constituting machine-readable media. The software may further be transmitted or received over a network via the network interlace device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Memory may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, 8010, SDHC cards); magnetic disks, (e.g., internal hard disks or removable disks); and optical disks (e.g., CD and DVD disks).

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A process for applying digital graphics directly onto surfaces, which comprises, in combination:
providing at least a fiberglass core and a desired image digitally rendered;
sizing and uploading said desired image into a printer, including profile calibration and color settings;
applying said at least a desired image to the surface whereby the integrity of the desired image digitally is rendered conformably, that is without spherical or chromatic aberration upon the surface; and
finishing over layers upon the surface to preserve by lamination the outer integrity of the surface of the now digitally conformably rendered image disposed upon said fiberglass core.

2. The process of claim 1, wherein the applying step further comprises the fiberglass core having a 4 HS (Harness-Satin) weave pattern.

3. The process of claim 2, further comprising the fiberglass core having a pre-specified warp yarn, and fill yarn setting.

4. The process of claim 3, the pre-specified warp yarn, and fill yarn setting. being ECE 225 1/0. (Yarn nomenclature diagram included below)

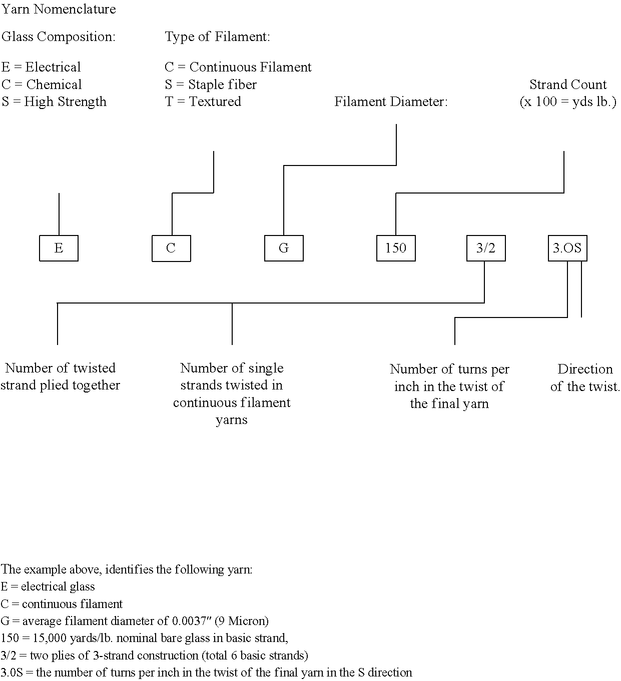

5. The process of claim 4, further comprising a warp of at least about 125 lbs/inch.

6. The process of claim 5, further comprising a fill of at least about 120 lbs/inch.

7. The process of claim 6, further comprising a 60×58 count of ends×picks per inch.

8. The process of claim 7, further comprising a weight of approximately 3.16 OSY (Ounces Per Square Yard).

9. The process of claim 8, further comprising a thickness of at least about 0.004 inches.

10. The process of claims 9, further comprising aerospace grade tightly woven 4 oz fiberglass.

11. The process of claim 10, wherein the finishing step further comprises application of a Siline finish.

12. The process of claim 11, whereby the Siline finish is compatible with both epoxy and Polyurethane resin.

13. A product, by the process of claim 12, wherein a least a fiberglass core is finished as a surfboard, and the digital elements are structural making the board more durable.

14. Products, by the process of claim 1, further comprising at least one recreational article selected from the group consisting of SUP paddle blades, surfboard fins pickleboard raquets and other articles having geometrically complex surface orientations.

15. A fiberglass-based article of manufacture having a digital image disposed thereupon, wherein there is no detectable level of spherical or chromatic aberration, when observed by the human eye within the digital image disposed thereupon, and the image is cross-linked into the fibers increasing structural integrity.

16. A system for operatively linking at least two processing units for scalably making fiberglass articles of manufacture having digital images conformably applied to a least a portion of its surface, comprising, in combination:
Providing data from a data source regarding the interface between at least a substrate which is a fiberglass core and data regarding a desired image digitally rendered;
sizing and uploading said data regarding desired image into a processor further comprising a printer, including profile calibration and color settings to drive the operation thereof;
applying said at least a desired image to the surface whereby the integrity of the desired image digitally is rendered conformably, that is without spherical or chromatic aberration upon the surface, on the basis of matching the surface topographical data set via the interface with data regarding a desired image digitally rendered; and
finishing over each of the respective articles of manufacture layers upon their respective surfaces to preserve by lamination the outer integrity of the surface of the now digitally conformably rendered images disposed upon said fiberglass cores, whereby structural integrity is enhanced by physical and chemical integration of the digitally conformed images to the surface contours of each of the articles of manufacture.
